(19) United States
(12) Patent Application Publication
(10) Pub. No.: US 2003/0196987 A1
(43) Pub. Date: Oct. 23, 2003

(54) Ultra fine patterning process for multi-layer substrate

(76) Inventors: Moriss Kung, Taipei (TW); Kwun-Yao Ho, Taipei (TW)

Correspondence Address: Raymond Sun, 12420 Woodhall Way, Tustin, CA, 92782, US

(21) Appl. No.: 10/269,770

(22) Filed: Oct. 14, 2002

(30) Foreign Application Priority Data
Apr. 23, 2002 (TW) 91108290

(51) Int. Cl. C23F 1/00; G11B 5/127

(52) U.S. Cl. 216/2

(57) ABSTRACT

The present invention discloses an ultra fine patterning process for multi-layer substrate by using selective deposition resist which inhibits metal nucleation during metal deposition process. The present invention can be executed by a fine pattern stamp adsorbing the self-assembled monolayers (SAM), then proceeds the stamping process on a surface of a substrate to achieve the selective deposited SAM with ultra fine pattern. Then, the metal deposition process will be proceeded to make metal deposited selectively on the portion not covered by the SAM to form the patterned metal layer directly.

### BACKGROUND OF THE INVENTION

(a) Field of the Invention

The present invention relates to a patterning process for multi-layer substrate by using selective deposition resist. Especially, the present invention relates to an ultra fine patterning process for multi-layer substrate by using selective deposition resist, which inhibits metal nucleation during metal deposition process. The process can be executed by a fine pattern stamp adsorbing the self-assembled monolayers (SAM), then proceeds the stamping process on a surface of a substrate to achieve the selective deposited SAM with ultra fine pattern.

(b) Description of the Prior Art

As the electronic product getting smaller and lighter, the circuit board and the substrate manufacturer now are facing the strict requirement for precise multiple layers integrated circuit substrate. The circuit layout placed on the substrate is using the vias and the PTHs to connect and conduct each other. Basically, the PTH is fully penetrating through a substrate, while a via is not when several substrates added together. In general, the diameter of the via or the PTH is less than 100 μm and its line width is less than 50 μm.

However, for the purpose of the density and the precision, the technology for manufacturing the micro via or the PTH with high density and high precision on the single or multiple layers integrated circuit substrate has been developed rapidly. And as the circuit board being widely used, with higher depth/width ratio, manufacturing PTH with good electrical characteristic on a substrate with high precision is the major concern for many manufacturers.

Please refer to FIG. 1A to FIG. 1D, which showing the manufacture process to produce the via on an integrated circuit substrate in prior art, as shown, the process is including the steps as follows:

(a) providing a base as the main body of integrated circuit substrate 10, and on the top and the bottom side of the integrated circuit substrate 10, placing the top and bottom metal layers 11 and 12 used to define the circuit layout later;

(b) allocating the position of the PTHs on the predetermined position on the surface of the integrated circuit substrate 10, punching by the mechanical drilling to form a plurality of through holes 13 on the integrated circuit substrate 10;

(c) plating a complete plane with copper 14 in the inner side of the through holes 13 to form the electrical conducting PTHs (Plated Trough Hole) 13a;

(d) proceeding Photolithograph, etching process on the circuit structure that being defined on the top and the bottom metal layer 11 and 12 on the top and the bottom surface of the integrated circuit substrate 10 to define the top and the bottom circuit layer 11a and 12a.

(e) proceeding the filling process on the PTH 13a by filling up the PTH 13a with a resin material such as the solder mask to form the complete structure of conducting plug 14, and the last step is to place the protection layer on the surface of the top and the bottom circuit layer 11a and 12a of the integrated circuit substrate 10 for protection purpose.

The description above is the general manufacturing process for a single layer integrated circuit substrate. Basically, defining the PTHs in the aforesaid process for the single layer integrated circuit substrate and stacking the single layer integrated circuit substrates together will form the complex multiple layers integrated circuit substrate.

The process described above has been developed for many years in prior art, however, the disadvantages still exist; such as bad reliability, bad yield and so on. The major causes are as follows,

1. Generally, the Photolithograph is used commonly in circuit layout manufacturing, however, it is time consuming and expensive.

2. Making high quality via is an extremely complex process, the time for making such product is much longer, the manufacturing facility needed is expensive and the manufacturing cost is also high.

As the descriptions, the integrated circuit substrate that being made thru the conventional process is with the weakness such as bad reliability and bad intensity in the conducting plug, it always fails to meet the requirement from customer, also, the market competition is weak and the production cost is high. Therefore, the improvement of the process for producing better vias on the integrated circuit substrate is the major concern that every substrate manufacturer focused.

### SUMMARY OF THE INVENTION

The primary aspect of the present invention is to provide an ultra fine patterning process for multi-layer substrate by using selective deposition resist, which could inhibit metal nucleation during metal deposition process; such as self-assembled monolayers (SAM), with stamping method to proceed the selective deposition process on a metal layer of a substrate to form ultra fine pattern, which is efficient and inexpensive.

In order to achieve the objects described above, the present invention is to provide an ultra fine patterning process for multi-layer substrate by using selective deposition resist, which comprises the following steps:

(a). providing a stamp formed by a master mold, the surface of the stamp has been patterned and the pattern is corresponding to the circuit layout on a substrate which will be processed in a succeeding process; dipping the stamp in a self-assembled monolayers solution to form a film;

(b). providing a substrate which is completed from a pre-process, and making the stamp touch the surface of the substrate;

(c). removing the stamp and the film attached over the substrate;

(d). depositing a metal layer, the metal layer is only formed on the portion not covered by the film and the patterned metal layer is formed directly;

(e). proceeding the surface treatment to remove the film not covered by the metal layer.

Also, the present invention can be used in the build-up process. A few dielectric layers can be placed on at least one side of a core substrate. The dielectric layers can be further printed with patterned stamp to make the film on the substrate, and the metal layer deposition will be applied to form directly the patterned metal layer, the blind via, and various types of holes for a multi-layer substrate.

Meanwhile, in the present invention, the stamp is not necessary to be patterned first; while the patterned dielectric layer of the substrate, the circuit board or the core board first existing, and the printing process proceeds with the film directly attached on the patterned dielectric layer, which omits the process of patterning the stamp master mold and makes the patterning process easier.

### BRIEF DESCRIPTION OF THE DRAWINGS

FIG. 1A to FIG. 1D show the pattern formation process for an integrated circuit substrate in prior art.

FIG. 2A to FIG. 2N show the first embodiment of the ultra fine patterning process for multi-layer substrate by using selective deposition resist of the present invention.

FIG. 3A to FIG. 3G show the second embodiment of the ultra fine patterning process for multi-layer substrate by using selective deposition resist of the present invention.

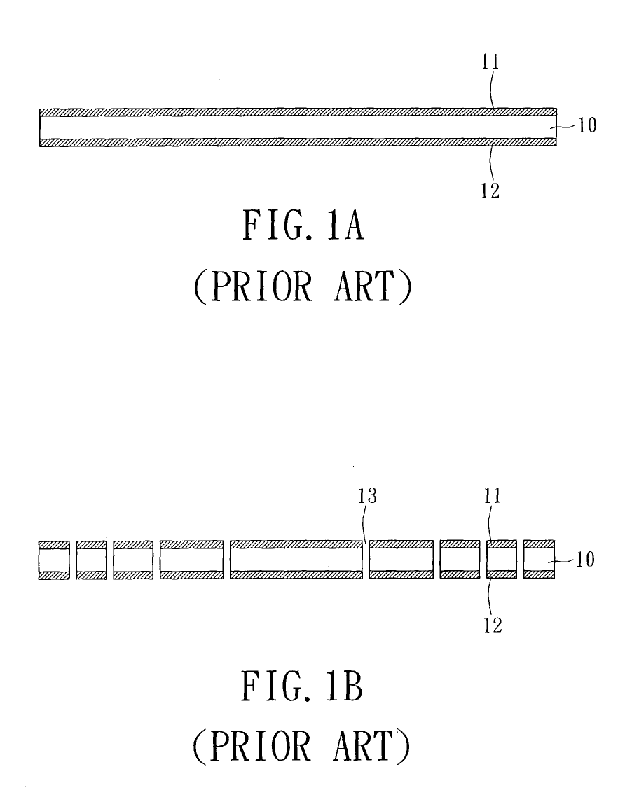

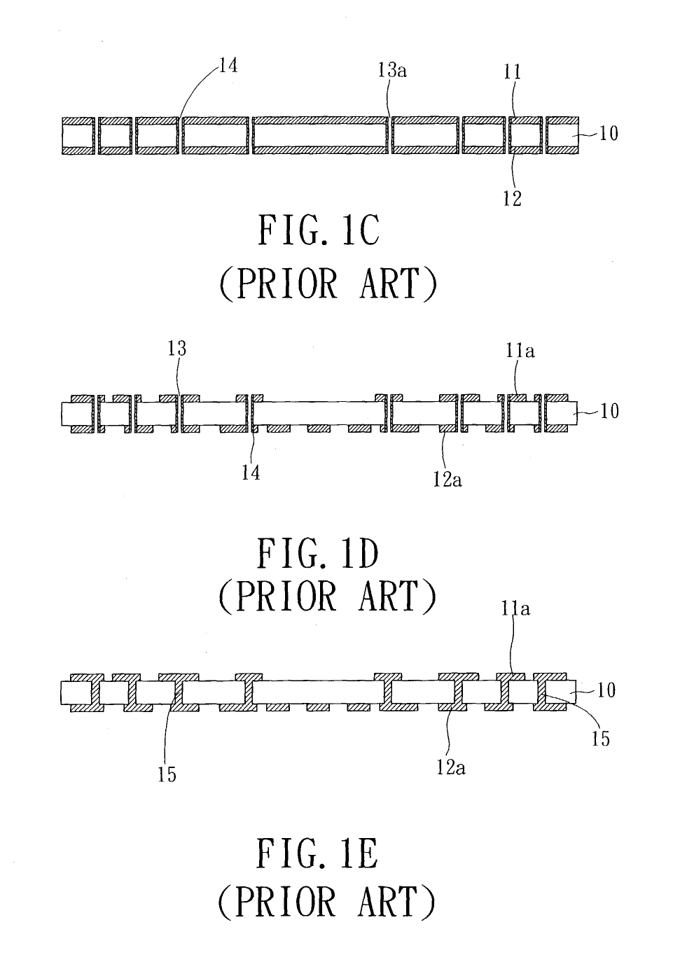

### DETAILED DESCRIPTION OF THE PRESENT INVENTION

The following embodiments will describe the ultra fine patterning process for multi-layer substrate by using selective deposition resist of the present invention about the detailed evolvement, the effect and the other technical characteristics. Various possible modification, omission, and alterations could be conceived of by one skilled in the art to the form and the content of any particular embodiment, without departing from the scope and the spirit of the present invention.

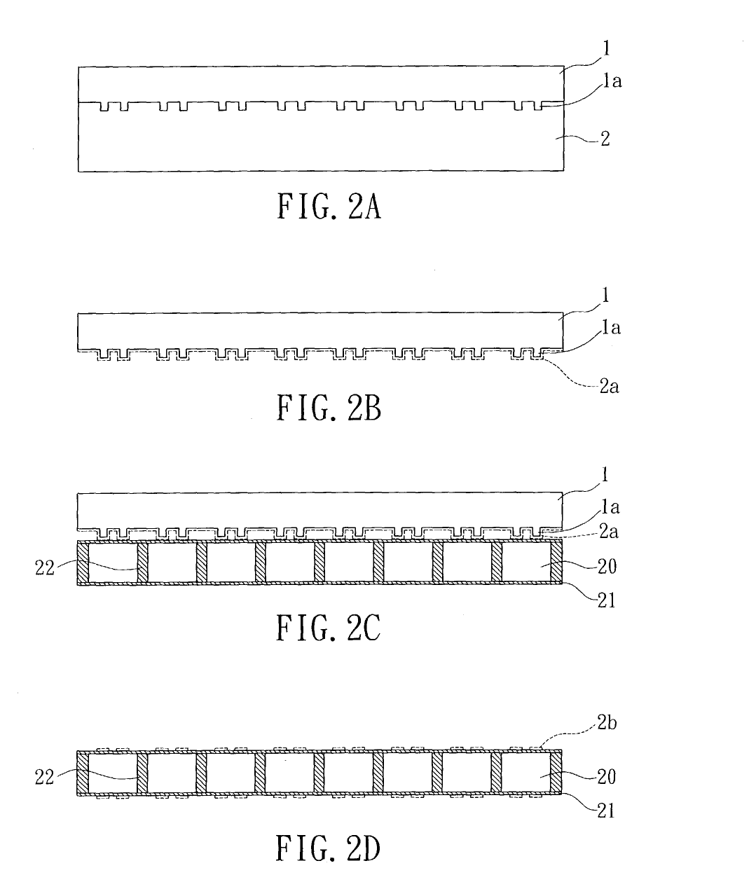

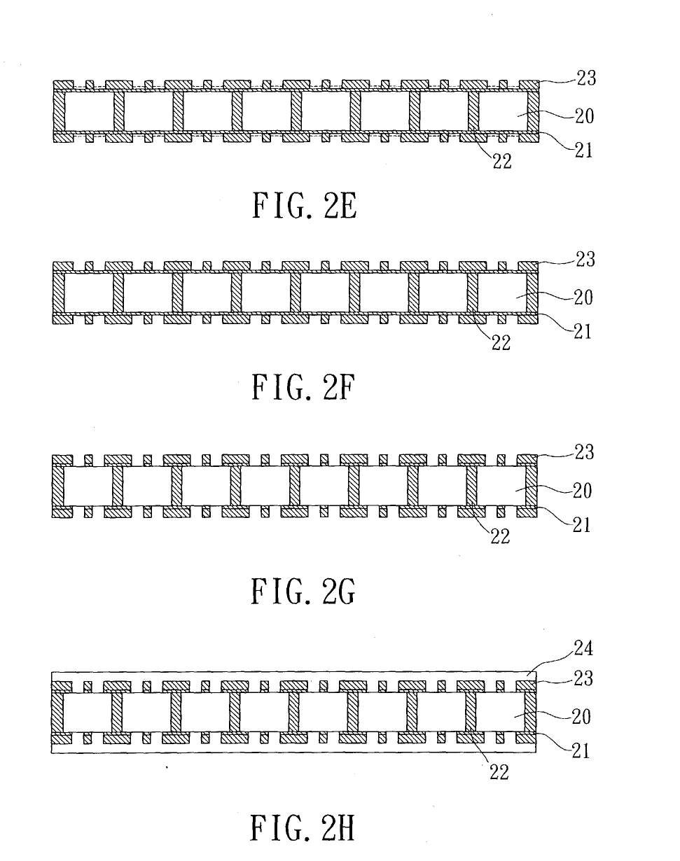

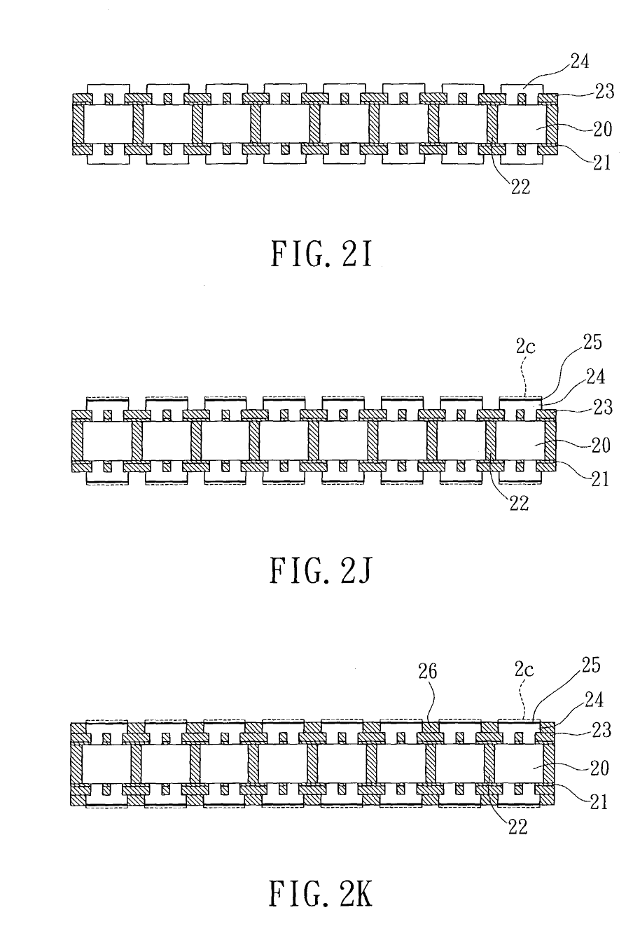

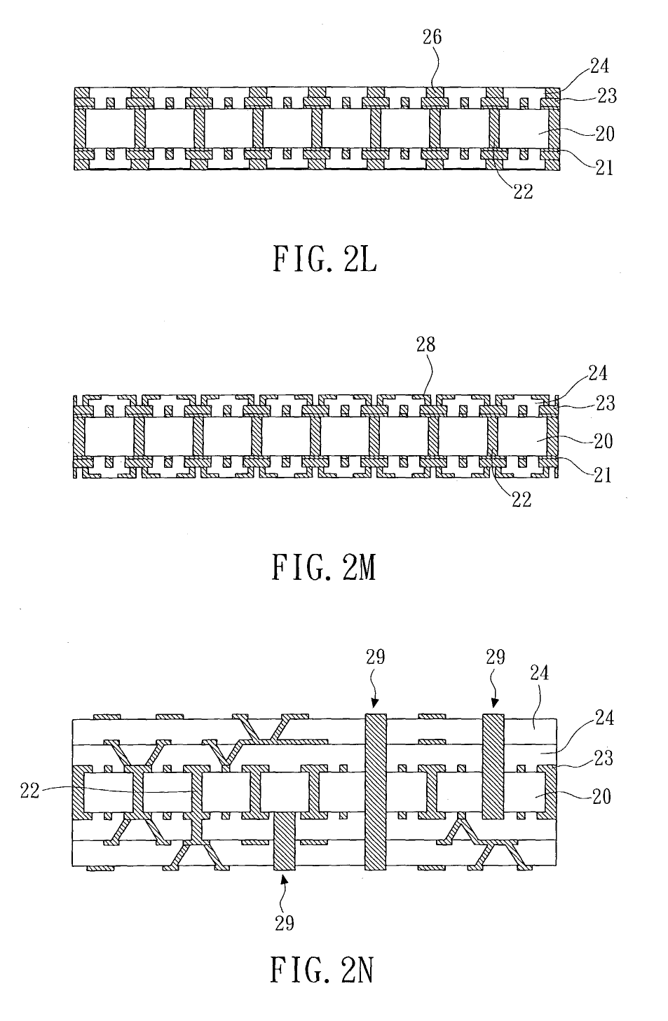

Please refer to FIG. 2A to FIG. 2N, which are showing the first embodiment of the ultra fine patterning process for multi-layer substrate by using selective deposition resist of the present invention, which comprising,

(a). providing a stamp 1 formed by a master mold, the stamp is made of elastomeric base; such as poly dimethalsiloxane (PDMS). The stamp I has been patterned with ultra fine pattern la which is corresponding to the circuit layout pattern on the substrate produced in a succeeding process; dipping the stamp 1 in a self-assembled monolayers solution 2, such as Octadecyltrichlorosilane, RsiCl3, Rsi(OCH3) etc. that are characteristic of inhibiting metal nucleation as shown in FIG. 2A.

(b). removing the stamp 1 from the self-assembled monolayers solution 2, as a result, a film characterized by metal nucleation inhibition is attached on the stamp 1, which is self-assembled monolayers (SAM) 2a as shown in FIG. 2B.

(c). providing one substrate 20, which can be a ceramic substrate, a plastic substrate, a soft material substrate, a metal substrate, a glass substrate, a circuit board or a core sheet; placing a copper layer on the top and bottom surface of these substrates or boards and placing some stuffed vias 22 on the predetermined position of the substrate—however, the copper layer is optional depending on different cases—then, attaching the stamp 1 on the surface of the substrate 2;

(d). removing the stamp 1 and making the self-assembled monolayers layer 2a on the stamp 1 print on the substrate 20, which attaching the self-assembled monolayers 2b on the substrate 20 and the pattern position that the self-assembled monolayers 2b placed on the substrate 20 is just as the pattern 1a on the stamp 1, which is as shown in FIG. 2D.

(e). depositing a first metal layer; such as Cu, Al, Zn, Ni or any other metal, on the surface of the substrate printed with the stamp, and since the self-assembled monolayers layer 2b printed on the substrate is characterized by metal nucleation inhibition, the first metal layer is only formed selectively on the portion not covered by the self-assembled monolayers layer 2b on the substrate 20 and the patterned metal layer 23 is formed directly; which is as shown in FIG. 2E;

(f). proceeding the surface treatment; such as the plasma etching to remove the self-assembled monolayers layer 2b, as shown in FIG. 2F;

(g). removing the uncovered copper layer 21 with the flash etching as shown in FIG. 2G; however, if the copper layer is optional, this process herein is subject to change accordingly;

(h). placing a dielectric layer 24 on the metal layer 23 and the dielectric layer can be a photo-imagible dielectric (PID) one or a laserable dielectric layer, as shown in FIG. 2H;

(i). if the dielectric layer 24 is a photo-imagible dielectric (PID) one, the process of Exposure and Photolithography will be applied further; if the dielectric layer 24 is a laserable dielectric layer, the laser drilling will be applied to make some pattern on the dielectric layer 24 to form some circuit layout, including patterned metal layer and vias, as shown in FIG. 21;

(j). depositing a thin metal layer 25 formed by the sputtering or the evaporation on the surface of the dielectric layer 24, and the metal layer can be of Cu, Al, Zn or any other metal; however, the metal layer 25 is optional depending on different case. Further, printing the second stamp on the surface of the substrate to attach the self-assembled monolayers on the thin metal layer 25, as shown in FIG. 2J;

(k). depositing a second metal layer on the most outside surface of the substrate 20; the metal layer can be of Cu, Al, Zn, Ni or any other metal, since the self-assembled monolayers 2c attached on the thin metal layer 25 of the substrate 20 is characterized by metal nucleation inhibition, the second metal layer will be formed selectively on the portion of the substrate 20 that is not covered by the self-assembled monolayers 2c; which is also the position of the circuit layout on the dielectric layer 24, to form directly the patterned metal layer 26, which is shown in FIG. 2K;

(l). removing part of the self-assembled monolayers 2c that is not covered by the metal layer 26 and removing the thin metal layer 25 with the flash etching as shown in FIG. 2L; certainly, this step is optional depending on different cases;

(m). in a different embodiment of the present invention; when depositing a metal layer on the most outside surface of the substrate, a more precise deposition method can be adapted with the self-assembled monolayers layer 2c characterized by metal nucleation inhibition to form a vary tiny metal layer 28 on the position of circuit layout of the dielectric layer 14, which is shown in FIG. 2M;

(n). illustrated in another embodiment of the present invention as shown in FIG. 2N, wherein the build-up process is adapted. Some dielectric layers 24 placed on the top and bottom surface of the substrate 20—which is used as a core—forms a multiple layers substrate. The dielectric layer 24 is attached with self-assembled monolayers by printing method, then, the metal deposition method is applied with Cu, Al, Zn or any other metal to form some patterned circuit layers, blind vias or various types of holes 29.

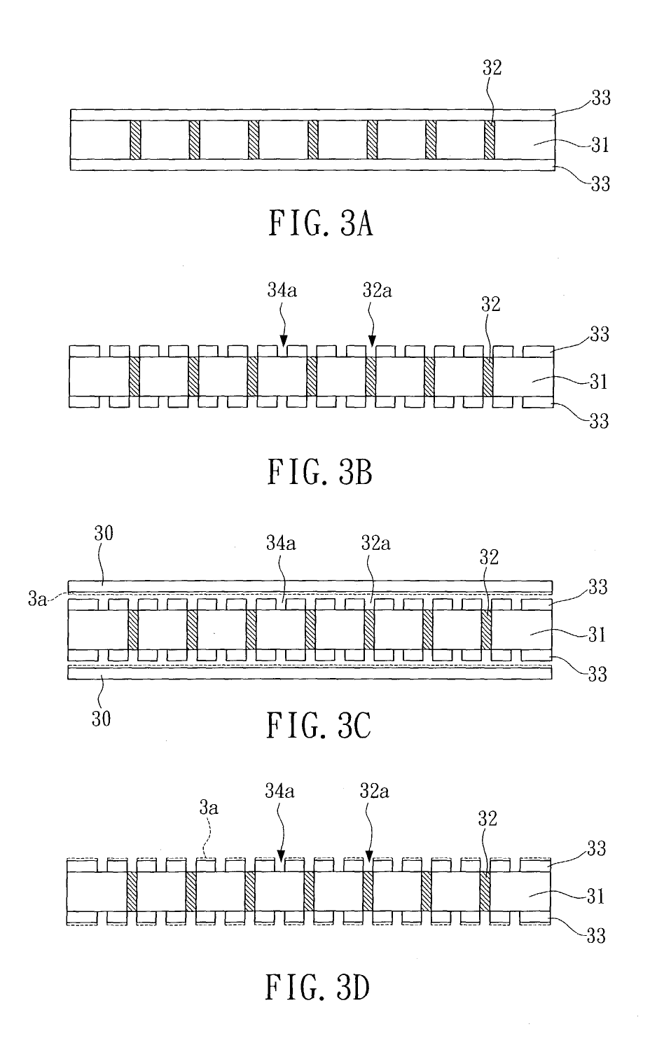

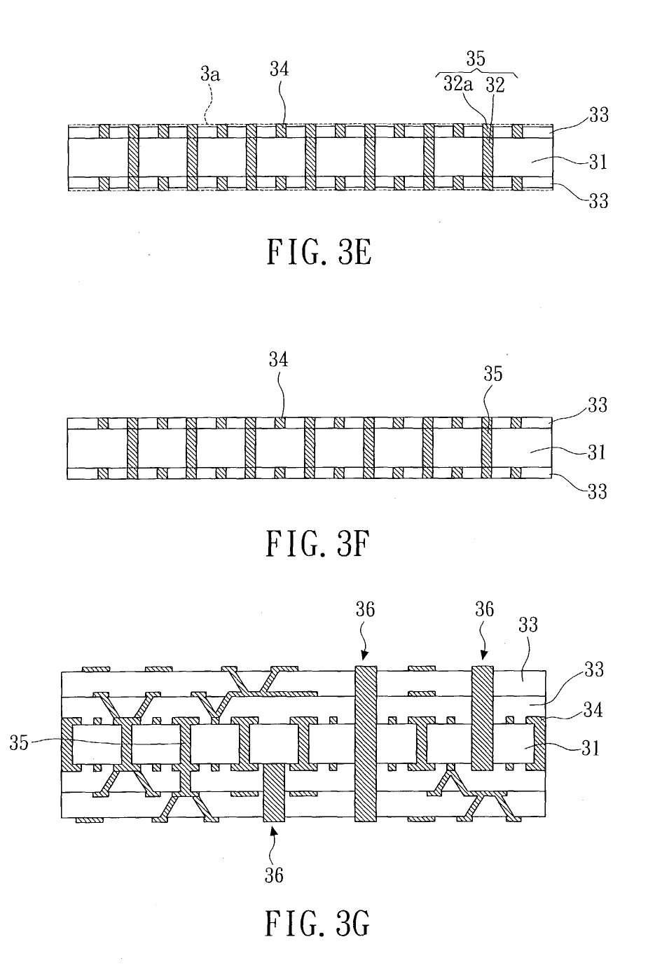

Please refer to FIG. 3A to FIG. 3G, which are showing the second embodiment of the ultra fine patterning process for multi-layer substrate by using selective deposition resist of the present invention, which comprising,

(a). providing one substrate 31, which can be a ceramic substrate, a plastic substrate, a soft material substrate, a metal substrate, a glass substrate, a circuit board or a core sheet; and some stuffed vias 32 penetrating through the substrate 31 have been formed on the predetermined positions on the substrate 31; placing a dielectric layer 33 on the surface of the substrate 31, which is a photo-imagible dielectric one or a laserable layer, as shown in FIG. 3A;

(b). if the dielectric layer 33 is a photo-imagible dielectric one, the process of Exposure and Photolithography will be applied further; if the dielectric layer 33 is a laserable dielectric layer, the laser drilling will be applied to make some pattern on the dielectric layer 33 to form some circuit layout, including patterned metal layer 34a and vias 32a, as shown in FIG. 2I;

(c). providing a stamp 30, the stamp is made of elastomeric base; such as poly dimethalsiloxane (PDMS). Differing from the first embodiment, the stamp 30 is not patterned but is a stamp with plane surface, further, a film characterized by metal nucleation inhibition; such as a self-assembled monolayer (SAM) 3a, is smeared over the stamp 30, and the self-assembled monolayer 3a can be made from the OTS, RsiCl3, and Rsi(OCH3) solution etc., finally, printing the stamp 30 on the surface of the substrate 31, as shown in FIG. 3C;

(d). removing the stamp 30, and making the self-assembled monolayers 3a on the stamp 30 print on the dielectric layer 33 on the substrate 31, which makes the self-assembled monolayers 3a attach on the patterned dielectric layer 33, as shown in FIG. 3D,

(e). depositing a first metal layer; such as Cu, Al, Zn or any other metal, on the most outside surface of the substrate 31, and since the self-assembled monolayers layer 3a printed on the dielectric layer 33 is characterized by metal nucleation inhibition, the first metal layer is only formed selectively on the portion not covered by the self-assembled monolayers layer 3a on the substrate 31 and the patterned circuit layout is formed directly, including the metal layer 34 and the via 35; which is as shown in FIG. 3E;

(f). proceeding the surface treatment; such as the plasma etching to remove the self-assembled monolayers layer 3a, as shown in FIG. 3F;

(g). other processes will be as same as described in previous embodiment. Certainnly, t−1Xhe present invention can be employed in different embodiment, as shown in FIG. 3G, wherein the build-up process is adapted. Some dielectric layers 33 placed on the top and bottom surface of the core substrate 31 forms a multiple layers substrate. The dielectric layer 33 is attached with self-assembled monolayers by printing method, then, the metal deposition method is applied with Cu, Al, Zn or any other metal to form some metal layers 34, blind vias or various types of holes 36.

The difference between the first and the second embodiment is that, in the first embodiment, the stamp is patterned first then is made with self-assembled monolayers, so when it is printed on a circuit board or a core substrate, the self-assembled monolayers will be attached thereon; however, in the second embodiment, the patterning process is applied on the dielectric layer on the substrate, the circuit board or the core substrate, then, the self-assembled monolayers is attached on the patterned dielectric layer during the printing process, which omits the process using the master mold to make the pattern stamp.

In stead of stuffing the via with the solder mask directly in prior art, the major difference in the present invention is that the present invention attaches the film; such as self-assembled monolayers, on the elastomieric base stamp and prints the stamp on the substrate; since the self-assembled monolayers is characterized by metal nucleation inhibition, which is selective deposition resist and forms patterned metal layer, the blind via and the holes only on the position not covered by the self-assembled monolayers.

Therefore, with the present invention, a vary tiny circuit layout; such as the one less than 100 μm or even 10 μm, can be made without using extra capture pad and expensive facility but highly increase the density of the circuit layout and the quality of substrate. More over, with the present invention, the manufacturing process is much easier and can be widely used in many fields for various size of substrate, totally overcome the disadvantages in prior art.

The description above is completely illustrating the ultra fine patterning process for multi-layer substrate by using selective deposition resist of the present invention. As illustrated, the present invention uses the precise patterned stamp to print tiny circuit layout on the substrate without the process of Exposure and Photolithography, which will not use expensive facility but highly increase the density of the circuit layout and the quality of substrate.

While the present invention has been shown and described with reference to a preferred embodiment thereof, and in terms of the illustrative drawings, it should be not considered as limited thereby. Various possible modification, omission, and alterations could be conceived of by one skilled in the art to the form and the content of any particular embodiment, without departing from the scope and the spirit of the present invention.

What is claimed is:

1. An ultra fine patterning process for multi-layer substrate, which comprising at least the following steps:
(a) providing a substrate which is completed from the pre-process;
(b) providing a stamp, the surface of the stamp has been patterned and is attached a film characterized by metal nucleation inhibition;
(c) printing the stamp on at least a surface of the substrate to make the film attach on the substrate;
(d) depositing a metal layer on the surface of the substrate printed with the stamp to form a patterned metal layer directly; and
(e) removing the film from the surface of the substrate.

2. The ultra fine patterning process for multi-layer substrate of claim 1, wherein the material made of the stamp is an elastomeric base.

3. The ultra fine patterning process for multi-layer substrate of claim 1, wherein the stamp is poly-dimethalsiloxane (PDMS).

4. The ultra fine patterning process for multi-layer substrate of claim 1, wherein the film is self-assembled monolayers (SAM).

5. The ultra fine patterning process for multi-layer substrate of claim 1, wherein the step (e) is a surface treatment for removing the film.

6. The ultra fine patterning process for multi-layer substrate of claim 5, wherein the surface treatment is plasma etching.

7. A ultra fine patterning process for multi-layer substrate, which comprising at least the following steps:
(a) providing a substrate which is completed from the pre-process, wherein at least one surface of the substrate is with a patterned dielectric layer;
(b) providing a stamp, the surface of the stamp is attached a film characterized by metal nucleation inhibition;
(c) printing the stamp on the patterned dielectric layer to make the film on the surface of the stamp attach on the patterned dielectric layer of the substrate;
(d) depositing a metal layer on the surface of the substrate to form a patterned metal layer directly; and
(e) removing the film from the surface of the substrate.

8. The ultra fine patterning process for multi-layer substrate of claim 7, wherein the material made of the stamp is an elastomeric base.

9. The ultra fine patterning process for multi-layer substrate of claim 7, wherein the stamp is poly-dimethalsiloxane (PDMS).

10. The ultra fine patterning process for multi-layer substrate of claim 7, wherein the film is self-assembled monolayers (SAM).

11. The ultra fine patterning process for multi-layer substrate of claim 7, wherein the step (e) is a surface treatment for removing the film.

12. The ultra fine patterning process for multi-layer substrate of claim 11, wherein the surface treatment is plasma etching.

13. The ultra fine patterning process for multi-layer substrate of claim 7, wherein the dielectric layer is a photo-imagible dielectric layer.

14. The ultra fine patterning process for multi-layer substrate of claim 7, wherein the dielectric layer is a laserable dielectric layer.
